(19) United States
(12) Patent Application Publication
(10) Pub. No.: US 2023/0017235 A1
(43) Pub. Date: Jan. 19, 2023

(54) DISPENSING AND SPRAYING MEMBER INTENDED FOR A CLEANING SYSTEM FOR A MOTOR VEHICLE SENSOR UNIT

(71) Applicant: Valeo Systemes d'Essuyage, La Verriere (FR)

(72) Inventors: Maxime BAUDOUIN, La Verriere (FR); Alexis LEYMARIE, La Verriere (FR)

(73) Assignee: Valeo Systemes d'Essuyage, La Verriere (FR)

(21) Appl. No.: 17/630,289

(22) PCT Filed: Jun. 29, 2020
(86) PCT No.: PCT/EP2020/068202

§ 371 Date: Aug. 29, 2022

(30) Foreign Application Priority Data
Jul. 31, 2019 (FR) FR1908795

(51) Int. Cl. B60S 1/52; B60S 1/56

(52) U.S. Cl. CPC B60S 1/522; B60S 1/566

(57) ABSTRACT

The invention relates to a dispensing and spraying member intended for a cleaning system for a sensor unit of at least two optical sensors, the dispensing and spraying member being configured to dispense and/or spray at least one cleaning fluid onto at least one first optical surface of the sensor block and said member comprising an arm, which extends along a longitudinal axis, at least one supply cannula and one discharge cannula for the cleaning fluid, the arm comprising at least one plurality of openings for spraying the cleaning fluid onto at least the first optical surface.

The present invention relates to the field of driving assistance and in particular to optical assemblies included in driving assistance systems, and it relates more particularly to driving assistance systems comprising an optical assembly and a system for cleaning the optical assembly.

Motor vehicles increasingly comprise driving assistance systems which can make it possible, in a lesser degree of autonomy of the vehicle, to assist with or to perform parking maneuvers as well as to carry out, in a maximum degree of autonomy of the vehicle, driving of the vehicle without a driver being present in the vehicle. Such driving assistance systems include in particular one or more optical assemblies, provided with optical sensors such as vision cameras or light wave sensors/emitters, these optical assemblies being able to detect an environment of the vehicle and able to evaluate parameters external to this vehicle.

The optical sensors are associated with at least one control unit which is configured to interpret the information so collected and to take the decisions which are necessary as a consequence of that information.

More particularly, the use of autonomous vehicles, without a driver, involves the use of a plurality of optical sensors which are arranged all around the vehicle, so that the control unit has a precise image of the environment of the vehicle. To that end, optical sensors can be placed as close as possible to one another so as to form blocks of sensors with first optical sensors capable of reproducing an image of the road scene by emitting and receiving waves, in particular laser waves, and second optical sensors of the vision camera type.

Driving assistance devices comprising an optical sensor or an optical sensor block are known to be installed outside vehicles at various locations, depending on the use to which they are put. They can thus be located in the region of the roof, of the rear or front bumpers of the vehicle, of the rear or front license plate of the vehicle, or on the sides of the vehicle or the side-view mirrors thereof.

Being arranged outside the vehicle, each sensor block is greatly exposed to being spattered with organic or inorganic dirt which can be deposited on the optical surface of the sensor block. A resulting deposit of dirt reduces the effectiveness of the driving assistance device, or even renders it inoperative, in particular in rainy weather where spray of rain and dirt can greatly affect the operability of the driving assistance device. Therefore, the optical surfaces of the optical sensors must each be cleaned in order to ensure that they remain in a good operating state.

For this purpose, it is known to integrate at least one cleaning system for at least one of the optical surfaces within the optical assembly. Different cleaning systems can be provided and in particular systems in which a cleaning fluid, for example water or cleaning fluid, is sprayed onto the optical surface. Cleaning can then be done only by spraying this fluid or else by combining this spraying with drying by compressed air or sweeping, it being understood that a cleaning solution using only sweeping is to be avoided due to the high sensitivity to scratches of some of the optical surfaces.

Watering solutions allowing the dispensing of cleaning fluid are known for systems for cleaning glazed surfaces, in particular by telescopic sprinklers which are placed in the field of vision of the optical sensor during the cleaning operation and which are retracted once this is done, or by fixed nozzles arranged around the perimeter of the glazed surface.

The invention aims to provide an alternative to existing cleaning systems, which is effective in particular when optical surfaces are to be cleaned within the same optical assembly, and more particularly when the latter comprises optical surfaces of different dimensions, resulting in particular from the use of optical sensors of different types.

The present invention thus aims to provide a cleaning system for at least two optical sensors of different dimensions, said cleaning system being pooled for the various optical sensors with a view to reducing the quantity of equipment on board the vehicle, and for compactness and simplicity of the cleaning system of the driving assistance system.

The invention proposes a dispensing and spraying member intended for a cleaning system for a sensor block of at least two optical sensors intended for a motor vehicle, the dispensing and spraying member being configured to dispense and/or spray at least one cleaning fluid onto at least one first optical surface to be cleaned of the sensor block, the dispensing and spraying member delimiting a first chamber for circulating the cleaning fluid and comprising a branch which extends along a longitudinal axis, the dispensing and spraying member comprising at least one supply cannula and one discharge cannula for the cleaning fluid, these being respectively fluidically connected to the first chamber, at least the discharge cannula extending in a direction substantially parallel to the longitudinal axis of the branch, characterized in that the branch comprises at least a plurality of spraying orifices for spraying the cleaning fluid onto at least the first optical surface, said spraying orifices opening into the first chamber.

By convention, throughout the present document, the qualifier “longitudinal” applies to the direction in which an axis of rotation of the cleaning system extends and/or to a direction parallel to the directrix defining the optical surface to be cleaned.

“Dispensing” means that the dispensing and spraying member is configured to circulate the cleaning fluid to at least one component of the cleaning system capable of spraying said cleaning fluid onto at least one optical surface of an optical assembly comprising said cleaning system. Within the dispensing and spraying member according to the invention, such a distribution function is at least provided by the first chamber and the discharge cannula and the first chamber.

“Spraying” means that the dispensing and spraying member directly sends the cleaning fluid onto at least the first optical surface of this same optical assembly. Within the dispensing and spraying member, such a function is implemented by the branch which comprises the plurality of orifices.

Advantageously, the dispensing and spraying functions of the spraying and dispensing member are directed toward two separate optical surfaces of two separate optical sensors of the optical assembly.

The dispensing and spraying member has a partially hollowed-out structure which delimits the first chamber, this first chamber extending on the one hand into a collecting zone, to which the cannulas and the branch are hydraulically connected, and on the other hand into the branch. The supply cannula, longitudinally interposed between the branch and the discharge cannula, brings the cleaning fluid into the first chamber at the level of the collecting zone, where the cleaning fluid circulates before being sent either to the branch, in order to be directly sprayed toward at least the first optical surface of the optical assembly, that is to say toward the discharge cannula, which distributes the cleaning fluid toward the cleaning system with a view to this being sprayed onto an optical surface distinct from the optical assembly, for example a second optical surface.

According to one feature of the invention, the supply cannula is longitudinally interposed, along the longitudinal axis, between the orifices and the discharge cannula.

According to one feature of the invention, a main dimension of the supply cannula extends perpendicularly to the longitudinal axis of the branch and the main dimension of the discharge cannula.

Advantageously, the dispensing and spraying member may be made of plastic, the dispensing and spraying member therefore exhibiting a certain flexibility which facilitates its installation in the cleaning system as well as a low cost of manufacture.

According to one feature of the invention, the dispensing and spraying member comprises two half-shells, the supply cannula and/or the discharge cannula being entirely borne by one of the half-shells.

A first half-shell can form a base of the dispensing and spraying member while a second half-shell forms a cover thereof. The two half-shells each have a structure of complementary shape which, when assembled, form the dispensing and spraying member and delimit the first chamber.

The first half-shell includes at least a first wall and a plurality of first side wall portions. Likewise, the second half-shell comprises at least a second wall, extending mainly parallel to the first wall when the two half-shells are assembled, and a plurality of second side wall portions which extend in the continuity of the first side wall portions of the first half-shell so as to form side walls of the dispensing and spraying member when the latter is assembled.

Alternatively, the first half-shell or the second half-shell may have the shape of an essentially planar plate, side edges of which constitute the side wall portions of the dispensing and spraying member. Such a plate can then be secured to the side wall portions of the complementary half-shell.

By way of example, the half-shells can be secured together by welding, in particular by ultrasonic welding.

In order to simplify the manufacture of the dispensing and spraying member, the supply cannula and the discharge cannula can be borne by only one of the two half-shells. In other words, the cannulas do not extend at the level of a connection interface of the two half-shells, for example formed by welding, keeping them secured to one another.

Also, in order to minimize the bulk of the cleaning system, the supply cannula and the discharge cannula can be arranged on the same half-shell, for example the second half-shell, forming the cover of the dispensing and spraying member, and in particular when the cover is formed by the half-shell arranged opposite the cleaning system on which the dispensing and spraying member is placed. In particular, the supply cannula and/or the discharge cannula can emerge from the second wall or from the second wall and from at least one of the second side wall portions of the second half-shell, said cannulas projecting from the half-shell.

The same applies when the supply cannula and/or the discharge cannula is borne by the first half-shell, it then being possible for at least one of said cannulas to emerge from the first wall or from the first wall and from at least one of the first side wall portions of the first half-shell.

In particular, the supply cannula and/or the discharge cannula can open into the first chamber via an oblong orifice.

According to one feature of the invention, at least one of the half-shells comprises at least one groove and the other half-shell comprises at least one complementary rib, the rib receiving the groove and the rib and/or the groove at least partially surrounding the first chamber.

The rib consists of a bead of material extending perpendicularly to the first wall and/or to the second wall of the dispensing and spraying member.

The groove and the rib may extend along the side walls and/or be at least partly included in said side walls so as to trace a periphery of the first chamber of the dispensing and spraying member. Such groove and rib can in particular contribute to ensuring the sealing of the dispensing and spraying member at the level of the various side walls.

Alternatively, one of the half-shells can comprise a plurality of ribs while the other half-shell comprises a plurality of complementary grooves. Similarly, each of the half-shells may include a combination of grooves and ribs complementary to a combination of grooves and ribs of the other half-shell.

Additionally, the half-shells may include at least one centering member, intended to ensure the adequate alignment of the two half-shells.

According to one feature of the invention, the spraying orifices are formed in at least one of the side walls of the branch.

Such spraying orifices can be obtained by perforating said side wall. When the dispensing and spraying member comprises the two half-shells, the spraying orifices may be arranged in at least one of the first side wall portions of the first half-shell, of the second half-shell, or at the connection interface securing said half-shells.

In particular, said spraying orifices can extend transversely to at least the rib and/or the groove of the dispensing and spraying member in order to open into the first chamber.

According to one feature of the invention, the spraying orifices and the supply cannula are formed on the same side of a longitudinal plane passing through the discharge cannula and extending parallel to at least the side wall.

According to one feature of the invention, the dispensing and spraying member comprises at least one fastening member intended to cooperate with a complementary fastening member of the cleaning system.

By way of example, the fastening member may consist of a clipping member and/or of an elastically deformable tenon. Such a fastening member can be arranged on at least one of the side walls of the dispensing and spraying member, for example so as to be borne by the first half-shell and/or the second half-shell.

In particular, the dispensing and spraying member can comprise a plurality of fastening members.

According to one feature of the invention, the dispensing and spraying member may comprise at least one element for guiding the dispensing and spraying member in the cleaning system.

The guide member may consist of a rail or a pair of rails which protrude from the first wall or from at least one of the side walls. By way of example, a plurality of guide elements can extend in the extension of two of the side walls of the dispensing and spraying member.

The invention also relates to a cleaning system for a sensor block of at least two optical sensors intended for a motor vehicle, the cleaning system comprising a dispensing and spraying member as claimed in any one of the preceding claims and the cleaning system comprising at least a first cleaning assembly comprising at least a first blade intended for cleaning by sweeping the first optical surface of a first optical sensor of the sensor block, a second cleaning assembly independently fastened to the first cleaning assembly on a fastening bearing, the second cleaning assembly comprising at least a second blade distinct from the first blade and intended for cleaning by sweeping a second optical surface of a second optical sensor of the sensor block, the branch of the dispensing and spraying member being configured to spray the cleaning fluid onto the first optical surface of the first optical sensor and the discharge cannula of the dispensing and spraying member being connected to the second cleaning assembly.

In other words, the dispensing and spraying member simultaneously sprays the cleaning fluid directly onto the first optical surface of the first sensor and indirectly onto the second optical surface, distinct from the first optical surface, of the second sensor. The direct spraying of the cleaning fluid is effected via the branch, while the indirect spraying is effected by distributing the cleaning fluid, via the discharge cannula, to a component of the second cleaning assembly configured to spray said cleaning fluid toward the second optical surface of the second optical sensor.

According to one feature of the invention, the second optical surface has a longitudinal dimension greater than that of the first optical surface. In this context, the direct spraying of the cleaning fluid, brought about by the dispensing and spraying member, via the branch and the spraying orifices, is carried out on the first optical surface, which is of smaller longitudinal dimension, while the indirect spraying, involving other components for the circulation of the cleaning fluid, is performed on the second optical surface.

It is thus noteworthy that the dispensing and spraying member offers a solution integrating the spraying orifices for cleaning an optical surface of small dimensions. This makes it possible to not have to manage the integration of cleaning fluid spraying devices in the cleaning assembly associated with this small-dimension optical surface, and to manage the implementation of the spraying orifices in a part which is of simplified design and manufacture, and which can in particular be obtained by injection molding of plastic material.

By way of non-limiting example, the second optical surface, on which the spraying is said to be indirect, that is to say via other components than the dispensing and spraying member, has a longitudinal dimension of the order of 30 to 200 mm, and the first optical surface, on which the spraying is said to be direct, has a longitudinal dimension of the order of 10 to 100 mm, it being understood that the values are here chosen so that the second optical surface is significantly larger than the first optical surface. For example, the envisaged value ranges could be of the order of 10 to 50 mm for the first optical surface and of the order of 100 to 200 mm for the second optical surface.

According to the invention, the second cleaning assembly comprises at least a second blade support, bearing the second blade, the second blade support comprising at least one channel for the circulation of the cleaning fluid, this being fluidically connected to the discharge cannula of the dispensing and spraying member, and a plurality of nozzles for spraying the cleaning fluid toward the first second optical surface of the second optical sensor, which nozzles open into said circulation channel.

In particular, the spraying nozzles of the second cleaning assembly, the supply cannula and the spraying orifices of the dispensing and spraying member are configured to be turned toward the sensor block. In particular, they can be arranged on the same side of the longitudinal plane of the dispensing and spraying member.

As previously explained, the dispensing and spraying member according to the invention is thus particularly intended for a sensor block of which the first optical sensor and the second optical sensor respectively comprise the first optical surface and the second optical surface, which have different longitudinal dimensions as measured along the axis of rotation of the cleaning system. In particular, the first optical surface can have smaller dimensions than the second optical surface.

The optical sensors can consist of sensors using light of the visible spectrum, the infrared spectrum and/or the ultraviolet spectrum. By way of example, the first optical sensor and/or the second optical sensor can be an optical camera, or light detection sensor, called LIDAR (from “Light Detection And Ranging”). Advantageously, the first optical sensor is of a different nature from the second optical sensor. For example, the first optical sensor is a vision camera and the second optical sensor is a LIDAR sensor, vision cameras being known to have smaller dimensions.

The first optical surface and the second optical surface are sized according to the nature of the first optical sensor and the second optical sensor. In particular, the optical sensor corresponding to a vision camera is characterized by a smaller optical surface than an optical sensor corresponding to a LIDAR sensor. In particular, according to the invention, the second optical surface of the second optical sensor, of the LIDAR type, is characterized by a longitudinal dimension greater than a longitudinal dimension of the first optical surface.

According to one feature of the invention, the cleaning system comprises a drive device in simultaneous rotation, about the common axis of rotation, with the first cleaning assembly and with the second cleaning assembly, the drive device comprising at least the fastening bearing on which each of the cleaning assemblies is fastened, the fastening bearing being configured to bear the dispensing and spraying member.

By way of example, the drive device may include at least one crank and an electric motor. The first cleaning assembly and the second cleaning assembly are driven in rotation by the electric motor via the crank which comprises the fastening bearing. The first cleaning assembly and the second cleaning assembly are distinct but their rotational displacement between a first resting end position, in which the cleaning assemblies are not in the field of vision of the optical sensors, and a second end position, in which the cleaning assemblies have swept the entire corresponding optical surface, is dependent on the same crank.

In particular, the fastening bearing may comprise at least the complementary fastening member intended to cooperate with at least the fastening member of the dispensing and spraying member, consisting for example of a clipping member.

The dispensing and spraying device, borne by the fastening bearing, is arranged so that the branch extends parallel to the first optical surface, the spraying orifices being turned toward said surface.

The guide element(s) of the dispensing and spraying member are configured to cooperate with the fastening bearing. By way of example, at least one of the guide elements of the dispensing and spraying member can slide along at least one lateral edge of the fastening bearing. Alternatively, the guide element(s) can be configured to cooperate with at least one complementary guide element of the fastening bearing.

The invention also relates to an optical assembly for a vehicle, comprising at least one sensor block and a cleaning system as previously set out, the sensor block comprising at least the first optical sensor and the second optical sensor superimposed on each other along the axis of rotation of the cleaning system, the first optical sensor comprising the first optical surface and the second optical sensor comprising the second optical surface, a first longitudinal dimension of the first optical surface, substantially parallel to the axis of rotation, being less than a second longitudinal dimension of the second optical surface, the cleaning system comprising the first cleaning assembly intended for cleaning the first optical surface and the second cleaning assembly intended for cleaning the second optical surface.

In particular, the first optical sensor and the second optical sensor can be centered on the axis of rotation. Advantageously, the first optical sensor and the second optical sensor are of substantially equal radial dimensions. The radial dimension is measured perpendicularly from the axis of rotation toward the optical surface of the optical sensor in question. Such a configuration makes it possible to simultaneously sweep the two optical surfaces of said optical sensors by means of its dedicated cleaning assembly, the cleaning assemblies being aligned along an axis parallel to the axis of rotation.

Alternatively, the optical sensors of the same sensor block may have different radial dimensions, since the fastening bearing common to the two cleaning assemblies is configured so that the two cleaning assemblies extend at different radial distances from the rotation axis.

The first cleaning assembly and the second cleaning assembly are each characterized by a length, respectively referred to as the first length and the second length. The first length and the second length may be respectively substantially equal to the first longitudinal dimension and the second longitudinal dimension, so that each of the cleaning assemblies sweeps the optical surface of the optical sensor with which it is associated over its entire longitudinal dimension.

Alternatively, at least one of the cleaning assemblies has a length less than the longitudinal dimension of the optical surface that it sweeps, the sweeping of the optical surface then being limited to the field of view of the optical sensor.

The first end position and the second end position of displacement of the cleaning system thus define the extent of the cleaned surface, corresponding to the field of vision necessary for the correct operation of said optical sensors.

In particular, the optical assembly is configured to cooperate with at least one control unit, the optical assembly and the control unit forming a driving assistance device.

Other features, details and advantages of the invention will become more clearly apparent upon reading the description given below by way of indication, with reference to the drawings, in which:

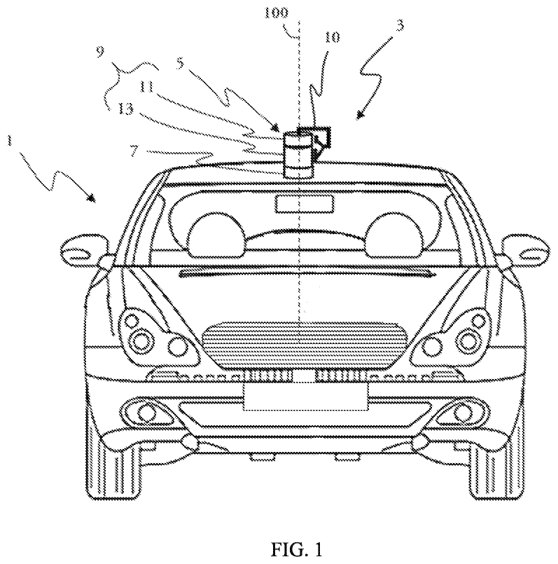

FIG. 1 is a general in-situ view of an optical assembly comprising a cleaning system according to the invention, in situ on the roof of a vehicle;

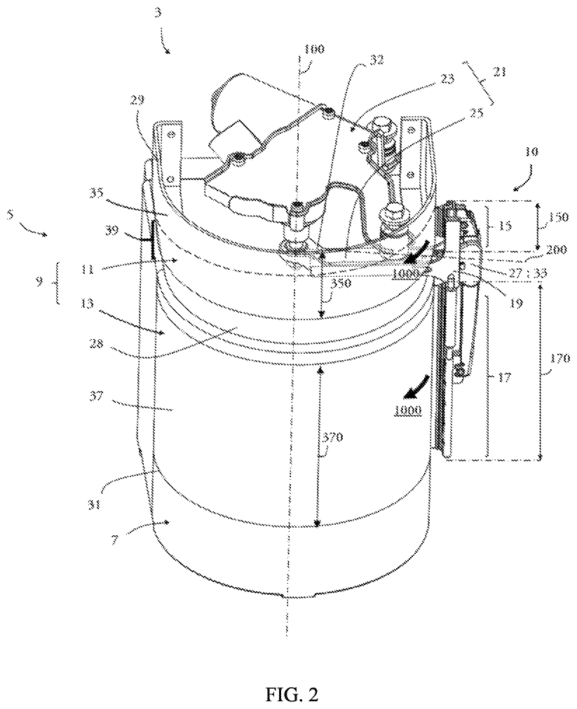

FIG. 2 is a schematic perspective view of one embodiment of the optical assembly of FIG. 1, comprising the cleaning system according to the invention;

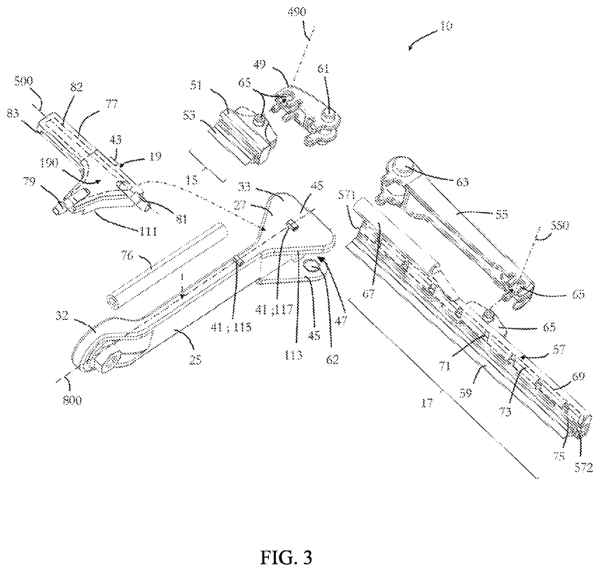

FIG. 3 is an exploded schematic perspective view of the cleaning system comprising a simplified dispensing and spraying member according to the invention;

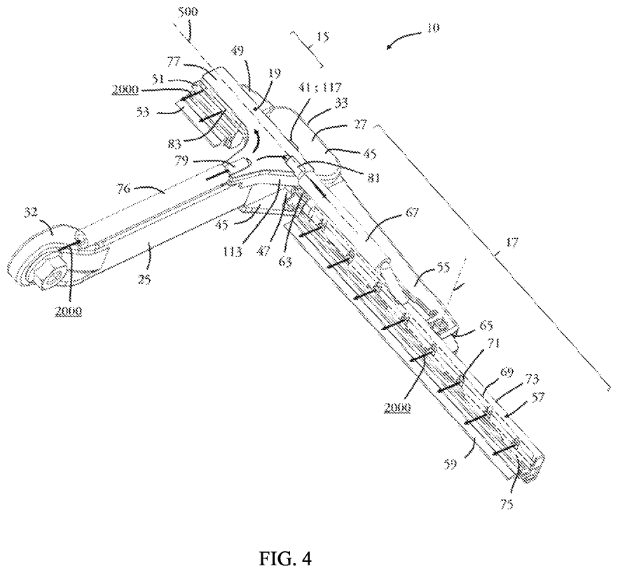

FIG. 4 is a perspective view of the cleaning system and of the dispensing and spraying member according to FIG. 3, when they are assembled;

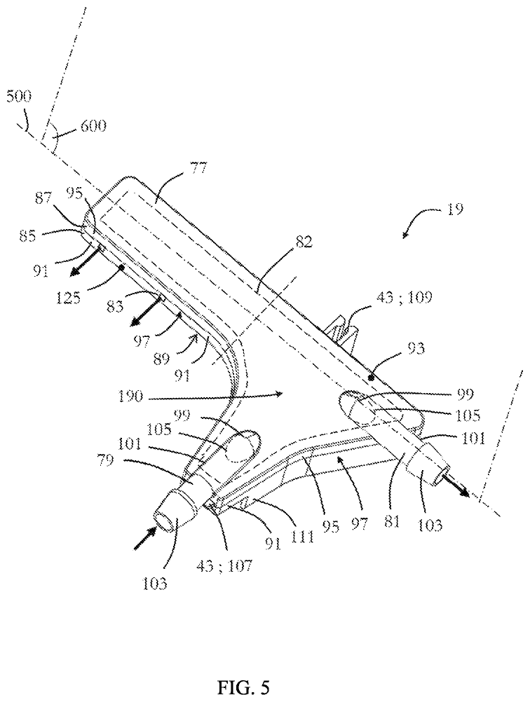

FIG. 5 is a perspective view of the dispensing and spraying member;

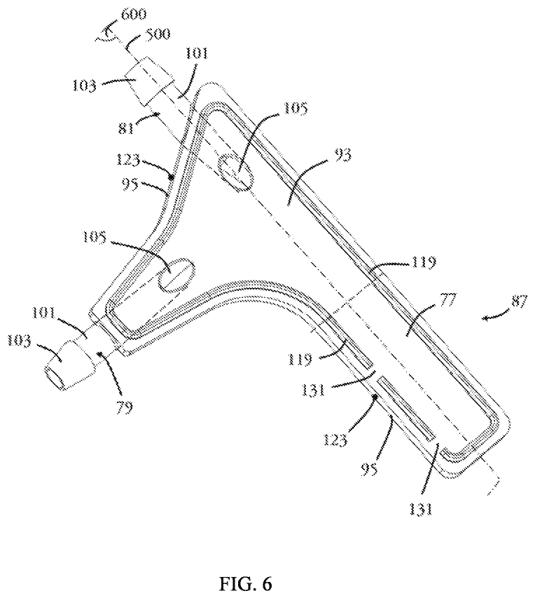

FIG. 6 is a perspective view of a half-shell, forming a cover for the dispensing and spraying member; and

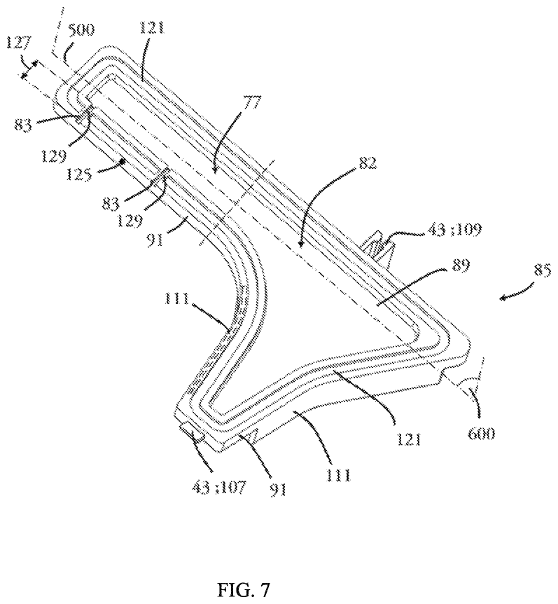

FIG. 7 is a perspective view of another half-shell, forming a base of the dispensing and spraying member, the half-shells of FIGS. 6 and 7 being configured to form the dispensing and spraying member of FIG. 5.

It should be noted in the first place that the figures show the invention in a detailed manner for the purpose of implementing the invention, it of course being possible to use said figures to define the invention more closely, where appropriate.

Referring first to FIG. 1, a motor vehicle 1 is provided with a driving assistance device 3 comprising an optical assembly 5 according to the invention and a control unit 7. The optical assembly 5 is fastened and centered on the roof of the motor vehicle 1, although the position and the number of optical assemblies may vary.

The optical assembly 5 comprises a sensor block 9, consisting of at least two sensors, and a cleaning system 10. In particular, the sensor block 9 comprises a first optical sensor 11 and a second optical sensor 13 that are superimposed on one another along an axis of rotation 100 of the cleaning system 10, it being also possible for said optical sensors 11, 13 to be superimposed on the control unit 7.

In the example in question, the first optical sensor 11 is a vision camera, and the second optical sensor 13 is a LIDAR sensor, standing for “Light Detection And Ranging”. The first optical sensor 11 and the second optical sensor 13 jointly detect the environment outside the motor vehicle 1 and generate data which they transmit to the control unit 7. Said control unit 7 is able to activate the cleaning system 10, for example periodically and/or when the field of vision of one and/or the other optical sensor 11, 13 is impaired.

FIG. 2 illustrates in more detail the optical assembly 5 comprising the cleaning system 10 and the sensor block 9. For the sake of clarity, the sensor block 9 is partially shown in transparency in order to reveal the cleaning system 10. The sensor block 9 is in particular arranged so as to be centered on the axis of rotation 100 of the cleaning system 10.

The cleaning system 10 comprises a first cleaning assembly 15, a second cleaning assembly 17, a dispensing and spraying member 19, ensuring the fluidic connection of each of said cleaning assemblies 15, 17, and a drive device 21 simultaneously rotating said cleaning assemblies 15, 17. The cleaning system 10 is movably mounted on the sensor block 9, so that it can be driven in rotational motion, illustrated by the arrows 1000, about the axis of rotation 100.

The drive device 21 comprises at least one electric motor 23 and a crank 25 comprising a fastening bearing 27 which bears the different cleaning assemblies 15, 17. The crank 25 extends along a radial direction 200 with respect to the axis of rotation 100 in a clearance zone 28 arranged between the first optical sensor 11 and the second optical sensor 13. The crank 25 connects the cleaning assemblies 15, 17 to the motor 23, the latter being able to simultaneously drive in rotation the first cleaning assembly 15 and the second cleaning assembly 17 of the cleaning system 10 between a first resting end position, in which the cleaning assemblies are not in the field of view of the optical sensors 11, 13, and a second end position, in which the cleaning assemblies have swept the entire corresponding optical surface, using the wiper blade borne by every cleaning assembly.

In the example illustrated, the motor 23 is arranged at a first longitudinal end 29 of the optical assembly 5, in the vicinity of the first optical sensor 11, while the control unit 7 is arranged at a second, opposite longitudinal end 31 of the optical assembly 5. Alternatively, the control unit 7 can be arranged at a distance from the sensor block 9.

The crank 25 comprises a first end 32, which cooperates with the electric motor 23 of the cleaning system 10, and a second end 33, opposite the first end 32, configured to bear the cleaning assemblies 15, 17, in particular via the intermediary of the fastening bearing 27.

Each of the cleaning assemblies 15, 17 is intended for sweeping an optical surface of a separate optical sensor. The first cleaning assembly 15 is intended for cleaning by sweeping a first optical surface 35 of the first optical sensor 11, while the second cleaning assembly 17 is intended for cleaning by sweeping a second optical surface 37 of the second optical sensor 13.

Due to the nature of the first optical sensor 11 and second optical sensor 13, respectively a vision camera and a LIDAR sensor, these are characterized by optical surfaces 35, 37 of distinct longitudinal dimensions, said longitudinal dimensions being measured parallel to the axis of rotation 100.

The second optical surface 37 of the second optical sensor 13 has a second longitudinal dimension 370 greater than a first longitudinal dimension 350 of the first optical surface 35 of the first optical sensor 11. It follows that, in order to be able to ensure the sweeping of such surfaces, the first cleaning assembly 15 is characterized by a first length 150, measured parallel to the axis of rotation 100, less than a second length 170 of the second cleaning assembly 17.

Also, it should be noted that, depending on the nature of the sensor, full sweeping of the optical surface may not be necessary. For example, and as shown, the field of view of the first sensor is limited to a lower portion 39 of the first optical surface 35, so that the first cleaning assembly 15 is sized to limit its sweeping action to this lower portion. In other words, the first length 150 of the first cleaning assembly 15 is less than the first longitudinal dimension 350 of the first optical sensor 11 and the first cleaning assembly 15 extends parallel to the first optical surface 35 only at the level of the lower portion 39 of the latter.

The same is true for the second optical sensor 13, so that the second cleaning assembly 17 can have a second length 170 substantially less than the second longitudinal dimension 370 of the second optical surface 37, so as to limit the sweeping to the portion of the second optical surface 37 corresponding to the field of view of the second optical sensor 13.

The first optical surface 35 and the second optical surface 37 both have semi-cylindrical structures that are coaxial and centered on the axis of rotation 100. In particular, they extend over an angular portion of approximately 180° corresponding to the maximum field of view of the first optical surface 35 and of the second optical surface 37. The first optical surface 35 and the second optical surface 37 extend in the longitudinal extension of one another, both being characterized by a substantially equal radial distance, measured along the radial direction 200 with respect to the axis of rotation 100.

The first optical sensor 11 being a vision camera, the first optical surface 35 is transparent and allows light of the visible spectrum to pass through. It can consist of glass advantageously treated with an anti-UV coating. The second optical surface 37, associated with the second optical sensor 13, of the LIDAR type, is capable of letting through the light waves emitted by a laser source and can consist, for example, of tinted polycarbonate, which can also be treated with an anti-UV coating.

There follows a more detailed description of the cleaning system, in particular with reference to FIGS. 3 and 4. As mentioned, the cleaning system 10 mainly comprises the first cleaning assembly 15, the second cleaning assembly 17, the dispensing and spraying member 19 and the crank 25 of the drive device 21.

The second end 33 of the crank 25 has a flare which forms the fastening bearing 27 of each of the brushes of the cleaning assemblies 15, 17 and of the dispensing and spraying member 19, the flare consisting of two mutually parallel triangular plates 45.

For fastening the dispensing and spraying member, the fastening bearing 27 comprises at least one complementary fastening member 41 protruding from one of the triangular plates 45, able to cooperate with at least one fastening member 43 of the dispensing and spraying member 19.

For fastening the cleaning assemblies, the fastening bearing 27 comprises, on either side of the body of the crank 25, receiving zones 47 of one end of a cleaning assembly. More particularly, each reception zone and the corresponding cleaning assembly are configured to allow a pivot connection, for example by cooperation of a lug in an appropriate orifice.

The first cleaning assembly 15 is in the form of a glazed surface wiper blade, with at least one arm, termed first arm 49, a first blade support 51, and a first blade 53. Similarly, the second cleaning assembly 17 is in the form of a glazed surface wiper blade, with at least one arm, termed second arm 55, distinct from the first arm 49, a second blade support 57, distinct from the first blade support 51, and a second blade 59, distinct from the first blade 53.

Each of the cleaning assemblies 15, 17 is fastened independently of the other on the fastening bearing 27. More particularly, one end of the first arm 49 is configured to provide a first articulation between the first cleaning assembly 15 and the fastening bearing 27, here by cooperation of first lugs 61 with blind holes made on the plates in the corresponding reception area. And one end of the second arm 55 is configured to provide a second articulation between the first cleaning assembly 15 and the fastening bearing 27, here by cooperation of second lugs 63 with blind holes 62 made on the plates in the reception area 47.

The triangular plates of the fastening bearing thus form, on either side of the body of the crank 25, independent articulation zones for each of the cleaning assemblies 15, 17. The first articulation and the second articulation are independent of each other, so that the pressing force on the appropriate optical surface of a particular cleaning assembly can vary, while the rotational drive is simultaneous.

The first arm 49 bears the first blade support 51. The same goes for the second arm 55, which bears the second blade support 57. The connection between the arm and the blade support is brought about by means of an adapter-connector system 65, these being mounted so as to pivot with respect to one another about a pivot axis 490, 550, respectively arranged at the level of the first arm 49 and of the second arm 55.

The first blade support 51 and the second blade support 57 respectively bear the first blade 53 and the second blade 59 so as to hold them longitudinally. The first blade 53 and the second blade 59 are made of a flexible and resistant material, for example a material such as rubber or polymer, capable of scraping any deposit of dirt from the optical surfaces of the optical assembly.

The second blade support 57 is in particular configured to spray the cleaning fluid onto the second optical surface 37 of the second optical sensor 13. To that end, it comprises an intermediate duct 67 for supplying the blade support with cleaning fluid, a circulation channel 69 internal to the body of the blade support and a plurality of spray nozzles 71 of the cleaning fluid arranged on this circulation channel.

The circulation channel 69 extends longitudinally in a body 73 of the second blade support 57. It forms a cylindrical recess which extends in part between a first termination 571 and a second termination 572, longitudinally opposite to the first termination 571, of the second blade support 57. The cleaning fluid 2000, in particular shown in FIG. 4, is brought into the circulation channel 69 by the intermediate duct 67 which opens into said circulation channel 69 in the body 73 and which emerges from the body 73 to be connected to an external supply circuit. The intermediate duct 67 here comprises at least one portion which extends at least partly parallel to the second blade support 57.

The spraying nozzles 71 are arranged in the body 73 of the second blade support 57 so as to spray the cleaning fluid toward the second optical surface. They each open into the circulation channel 69 of the body 73 of the second blade support 57 and are oriented toward the second optical surface.

The second blade support 57 also includes a plurality of tabs 75 which hold the first blade 53 in the second cleaning assembly 17.

The first cleaning assembly 15 having a first length 150 less than the second length 170 of the second cleaning assembly 17, the first blade 53 has a longitudinal dimension less than that of the second blade 59. Likewise, the first blade support 51 is of smaller longitudinal dimension than that of the second blade support 57, the first cleaning assembly 15 and the second cleaning assembly 17 thus being proportioned with respect to the first optical surface and with respect to the second optical surface, respectively.

Also, and as previously discussed for the dimensions of the cleaning assemblies, the first length 150 of the first cleaning assembly 15 is less than the longitudinal dimension of the first optical surface so that it only sweeps the field of view of the first sensor and not its entire longitudinal dimension. Conversely, the second length 170 of the second cleaning assembly 17 is substantially equal to the longitudinal dimension of the second optical surface. As a result, the second blade 59 scrapes the second optical surface over its entire longitudinal dimension.

Each of the cleaning assemblies 15, 17 is configured to ensure the spraying of the cleaning fluid 2000 onto the optical surface which it sweeps. More particularly, in the cleaning system 10 according to the invention, the spraying of the cleaning fluid is ensured by separate means within the first cleaning assembly 15 and the second cleaning assembly 17, in particular thanks to the design of the dispensing and spraying member 19.

The cleaning fluid 2000 is brought from an reservoir external to the optical system, to the cleaning assemblies 15, 17, by a connecting pipe 76 and by the dispensing and spraying member 19.

The connecting pipe 76 has a tubular shape and is arranged along the crank 25 of the drive device 21, between the first end 32 and the fastening bearing 27.

In order to allow the hydraulic connection of the first cleaning assembly 15 and of the second cleaning assembly 17 to this connecting pipe 76, the dispensing and spraying member 19 comprises a collecting zone 190 whence emerge a branch 77 and two cannulas, in particular a supply cannula 79 and a discharge cannula 81 for discharging the cleaning fluid from the dispensing and spraying member 19.

The dispensing and spraying member 19 has a substantially “T”-shaped structure, and comprises within it a first chamber 82 for circulating the cleaning fluid which extends both in the collecting zone 190 and in the branch 77.

The branch 77 is parallelepipedal in shape and extends along a longitudinal axis 500. It comprises a plurality of spraying orifices 83 intended to spray the cleaning fluid toward the first optical surface of the first optical sensor. To that end, the spraying orifices 83, like the spraying nozzles 73, are turned toward the optical surface to be treated and the spraying orifices open out inside the branch 77 onto the first chamber 82.

The discharge cannula 81 extends parallel to the longitudinal axis 500, for example so as to be centered on said longitudinal axis 500 and it is configured to cooperate with the intermediate duct 67. The supply cannula 79 extends perpendicularly to the longitudinal axis 500 and is interposed longitudinally, along the longitudinal axis 500, between the spraying orifices 83 of the branch 77 and the discharge cannula 81. The structure of the dispensing and spraying member 19 will be further detailed below.

When the cleaning system 10 is assembled, the dispensing and spraying member 19 is arranged at the level of the fastening bearing 27 of the crank 25. It is fluidically connected to the connecting pipe 76 by the supply cannula 79.

In the example illustrated, the supply cannula 79 is inserted into the connecting pipe 76, the latter having a larger diameter than the supply cannula 79. Alternatively, the cleaning system 10 could have the reverse configuration, so that the supply cannula 79 surrounds the connecting pipe 76.

The branch 77 of the dispensing and spraying member 19 extends parallel to the first cleaning assembly 15 and more specifically to the first blade support 51. In particular, the dispensing and spraying member 19 is not in direct contact with the first cleaning assembly 15.

The cleaning fluid is thus brought into the cleaning system 10 via the connecting pipe 76, then it enters the dispensing and spraying member 19 at the level of the collecting zone 190, via the supply cannula 79. It circulates in the first chamber 82, which has a flared structure to promote the dispensing of the cleaning fluid either toward the branch 77, in the direction of the first cleaning assembly 15, or toward the discharge cannula 81, toward the second cleaning assembly 17. The cleaning fluid circulating in the first chamber 82 at the level of the branch 77 then passes through the spraying orifices 83 and is sprayed onto the first optical surface of the first optical sensor, while the cleaning fluid sent to the discharge cannula 81 passes successively through the intermediate duct 67 and into the circulation channel 69 integrated in the second cleaning assembly, then it passes through the spraying nozzles 71 in order to be sprayed onto the second optical surface of the second optical sensor.

FIGS. 5 to 7 further illustrate the dispensing and spraying member 19 as briefly described above.

The dispensing and spraying member 19 may comprise two half-shells of complementary shape which, when assembled, form the dispensing and spraying member 19 and delimit the first chamber 82 within this member.

A first half-shell 85 forms a base of the dispensing and spraying member 19 while a second half-shell 87 forms a cover, of shapes and dimensions complementary to those of the first half-shell.

The first half-shell 85 includes a first wall 89 and a plurality of first side wall portions 91. Likewise, the second half-shell 87 comprises a second wall 93, extending parallel to the first wall 89, and a plurality of second side wall portions 95. The second side wall portions 95 extend in continuity with the first side wall portions 91 of the first half-shell 85 so that the first side wall portions 91 and the second side wall portions 95 form side walls 97 of the dispensing and spraying member 19 when the latter is assembled, the half-shells 85, 87 being, for example, secured by welding, in particular by ultrasonic welding.

Alternatively, the dispensing and spraying member 19 could be made in one piece.

The supply cannula 79 and the discharge cannula 81 emerge from the second half-shell 87, more specifically from the second wall 93 and from one of the second side wall portions 95 of the second half-shell 87. Each of the cannulas comprises an elbow 99 and a rectilinear segment 101 which extends parallel to the second wall 93. Each of the rectilinear segments 101 of the supply cannula 79 and of the discharge cannula 81 has, at a free end, a frustoconical head 103 forming a shoulder on the rectilinear segment, intended to seal the fluid connection between said cannulas and the connecting cannula 76 and the intermediate duct 67 of the cleaning system, respectively.

In particular, the supply cannula 79 and/or the discharge cannula 81 can each, as shown, open into the first chamber 82 of the dispensing and spraying member 19 at an oblong orifice 105, intended to promote the circulation of the cleaning fluid. Alternatively, the orifice can be circular.

In the example illustrated, the supply cannula 79 and the discharge cannula 81 emerge from the second half-shell 87, and it should be noted that this second half-shell 87 is the half-shell facing away from each cleaning assembly 15, 17, so that the fluid connection of the dispensing and spraying member 19 does not risk hampering the spraying of fluid onto the optical surfaces or even the sweeping of the glazed surface by the corresponding cleaning assemblies.

The spraying orifices 83, here two in number, are formed in one of the side walls 97 of the dispensing and spraying member 19, in particular in the side wall 97 which is provided on the same side, as the supply cannula 79, of a longitudinal plane 600 that is parallel to the side wall 97 and passes through the discharge cannula.

In particular, according to the example illustrated, the spraying orifices 83 may be formed in one of the first side wall portions 91 of the branch 77. Alternatively, the spraying orifices 83 can be arranged in one of the second side wall portions 95 of the branch 77 or else at the connection interface of the first half-shell 85 and of the second half-shell 87, so that the spraying orifices 83 extend into the first side wall portion 91 and into the second side wall portion 95.

By way of example, the spraying orifices 83 can be rectangular or circular, such spraying orifices 83 being obtainable by perforating said side wall 97.

The dispensing and spraying member 19 may comprise at least one fastening member 43 for fastening the dispensing and spraying member 19 in the cleaning system 10, this being configured to cooperate with a complementary fastening member 41 arranged in the fastening bearing 27, in particular visible in FIGS. 3 and 4.

The dispensing and spraying member 19 shown in FIGS. 5 to 7 comprises two fastening members 43 arranged in opposition to one another and borne by the first half-shell 85. Alternatively, at least one of these fastening members can be integrated, at least partially, in the second half-shell 87.

In the illustrated configuration, a first fastening member consists of a tenon 107, which in this case is rectangular and flat, which emerges from the first side wall portion 91 and extends parallel to the first wall 89 of the first half-shell 85.

A second fastening member consists of a clipping element 109 which comprises two mutually parallel elastic tongues which extend perpendicularly to the longitudinal plane 600. Each elastic tongue is able to be deformed during the installation of the dispensing and spraying member on the bearing, to prevent, by an elastic return force, the disengagement of one relative to the other.

It should be noted that this example of fastening with two fastening members does not limit the invention, and that the dispensing and spraying member 19 may also include a single fastening member 43, borne by one or other of the half-shells 85, 87, and/or be fastened by other fastening means such as adhesive elements.

The dispensing and spraying member 19 also comprises two guide elements 111. These guide elements 111 consist of two curved rails, borne by the first half-shell 85, these guide elements projecting from that face of the dispensing and spraying member 19 that is intended to be opposite the fastening bearing 27. More particularly, in the example illustrated, at least one rail forming a guide element is configured to extend in the extension of a first side wall portion 91, and therefore in the extension of a side wall 97 of the dispensing and spraying member 19. In particular, the guide elements 111 are arranged in the first half-shell 85, which does not directly bear the supply cannula 79 and discharge cannula 81.

The guide elements 111 are configured to allow insertion by sliding of the dispensing and spraying member 19 on the fastening bearing 27. They are in particular configured to slide along a side edge 113 of the fastening bearing 27, shown in FIGS. 3 and 4.

Thus, when the dispensing and spraying member 19 is mounted on the fastening bearing 27 of the cleaning system 10, a first complementary fastening member 115 of the fastening bearing 27, configured to cooperate with the tenon forming the first fastening member 107 of the dispensing and spraying member 19, and a second complementary fastening member 117 of the fastening bearing 27, configured to cooperate with the clipping element forming the second fastening member 109 of the dispensing and spraying member 19, surround the dispensing and spraying member 19. Such complementary fastening members prevent the movement of the dispensing and spraying member 19 on the fastening bearing 27 and the crank 25, along a transverse direction 800 which is perpendicular to the longitudinal axis 500 and parallel to a longest dimension of the crank 25.

Likewise the guide elements 111, which extend on either side of the fastening bearing 27, along at least two of its lateral edges 113, prevent the movement of the dispensing and spraying member 19 on the fastening bearing 27, along the direction defined by the longitudinal axis 500.

FIGS. 6 and 7 detail the internal configuration of the dispensing and spraying member 19 as shown in FIG. 5. Each of the half-shells of the dispensing and spraying member 19 comprises at least one rib 119 and/or a groove 121 of complementary shapes, the groove 121 receiving the rib 119 when the two half-shells are assembled one on top of the other. In the configuration shown, the first half-shell 85, forming the base of the dispensing and spraying member 19, comprises the groove 121, while the second half-shell 87, forming its cover, comprises the rib 119.

The rib 119 consists of a bead of material extending perpendicularly to the second wall 93 of the second half-shell 87. The second half-shell 87 has the shape of a plate, side faces 123 of which constitute the second portions of the side walls 95 of the dispensing and spraying member 19. The rib 119 protrudes from an internal face of said plate, that is to say a face turned toward the other half-shell when these two half-shells are assembled one on top of the other. The rib 119 helps to delimit the contour of the first chamber 82 of the dispensing and spraying member 19. As can be seen in FIG. 6, the oblong orifices 105 ensuring fluid communication at the inlet and outlet of the dispensing and spraying member 19 open onto this internal face of the plate forming the second half-shell, inside the zone delimited by the rib 119.

The groove 121 is included in the first half-shell 85, which forms the base of the dispensing and spraying member 19. The groove 121 forms a trench which extends partly into a thickness 127 of the first side wall portions 91 and at least partly surrounds the first chamber 82 for circulation of the cleaning fluid.

Thus, the first chamber 82 is delimited by the first wall 89, the second wall 93 and the first side wall portions 91, the groove 121 and the rib 119 ensuring the sealing of the dispensing and spraying member 19 at the level of the connection interface between the first half-shell 85 and the second half-shell 87.

As mentioned above, in the example illustrated the first half-shell 85 comprises the spraying orifices 83 at the level of one of the side walls of the branch 77, and more particularly at the level of the first side wall portion 91, configured to face the first optical surface 35 of the first optical sensor 11. The spraying orifices 83 extend through the first side wall portion 91 of the first half-shell 85, from an external face 125 and into the first chamber 82 of the dispensing and spraying member 19. The spraying orifices 83 extend transversely to the groove 121, interrupting the latter at two breakthroughs 129.

The same goes for the rib 119, which has two interruptions 131 allowing the spraying orifices 83 to open into the first chamber 82 and allowing the cleaning fluid to be sprayed outwards from the dispensing and spraying member.

It will be understood from reading the foregoing that the present invention proposes a dispensing and spraying member intended for a cleaning system configured to clean at least two optical sensors, of distinct longitudinal dimensions, arranged one on top of the other. The dispensing member, on the one hand, sprays a cleaning fluid onto a first optical surface of a first optical sensor, which surface is swept by a first cleaning assembly. The dispensing and spraying member, on the other hand, establishes the fluidic connection to a first cleaning assembly configured to spray the cleaning fluid onto a second optical surface of a second optical sensor.

The invention is not however limited to the means and configurations described and illustrated here, and it also encompasses any equivalent means or equivalent configuration and any workable technical combination of such means. In particular, the number of spraying orifices, the type and the number of fastening members or guide elements can be modified without harming the invention, insofar as the cleaning system ultimately fulfills the same functionalities as those described in this document.

1. A dispensing and spraying member (19) intended for a cleaning system (10) for a sensor block (9) of at least two optical sensors (11, 13) intended for a motor vehicle (1), the dispensing and spraying member (19) being configured to dispense and/or spray at least one cleaning fluid onto at least one first optical surface (35) to be cleaned of the sensor block (9), the dispensing and spraying member (19) delimiting a first chamber (82) for circulating the cleaning fluid and comprising a branch (77) which extends along a longitudinal axis (500), the dispensing and spraying member (19) comprising at least one supply cannula (79) and one discharge cannula (81) for the cleaning fluid respectively fluidically connected to the first chamber (82), at least the discharge cannula (81) extending in a direction substantially parallel to the longitudinal axis (500) of the branch (77), characterized in that the branch (77) comprises at least a plurality of spraying orifices (83) for spraying the cleaning fluid onto at least the first optical surface (35), said spraying orifices (83) opening into the first chamber (82).

2. The dispensing and spraying member (19) according to the preceding claim, wherein the supply cannula (79) is interposed longitudinally, along the longitudinal axis (500), between the orifices and the discharge cannula (81).

3. The dispensing and spraying member (19) according to the preceding claim, wherein a main dimension of the supply cannula (79) extends perpendicular to the longitudinal axis (500) of the branch and the main dimension of the discharge cannula (81).

4. The dispensing and spraying member (19) according to any one of the preceding claims, wherein the dispensing and spraying member (19) comprises two half-shells (85, 87), the supply cannula (79) and/or the discharge cannula (81) being entirely borne by one of the half-shells (85, 87).

5. The dispensing and spraying member (19) according to the preceding claim, wherein at least one of the half-shells (85, 87) comprises at least one groove (121) and the other half-shell comprises at least one complementary rib (119), the rib (119) receiving the groove (121) and the rib (119) and/or the groove (121) at least partially surrounding the first chamber (82).

6. The dispensing and spraying member (19) according to any one of the preceding claims, wherein the spraying orifices (83) are formed in at least one side wall (97) of the branch (77).

7. The dispensing and spraying member (19) according to the preceding claim, wherein the spraying orifices (83) and the supply cannula (79) are arranged on the same side of a longitudinal plane (600) passing through the discharge cannula (81) and extending parallel to at least the side wall (97).

8. A cleaning system (10) for a sensor block (9) of at least two optical sensors (11, 13) intended for a motor vehicle (1), the cleaning system (10) comprising a dispensing and spraying member (19) according to any one of the preceding claims and the cleaning system (10) comprising at least a first cleaning assembly (15) comprising at least a first blade (53) intended for cleaning by sweeping the first optical surface (35) of a first optical sensor (11) of the sensor block (9), a second cleaning assembly (17) independently fastened to the first cleaning assembly (15) on a fastening bearing (27), the second cleaning assembly (17) comprising at least a second blade (59) distinct from the first blade (53) and intended for cleaning by sweeping a second optical surface (37) of a second optical sensor (13) of the sensor block (9), the branch (77) of the dispensing and spraying member (19) being configured to spray the cleaning fluid onto the first optical surface (35) of the first optical sensor (11) and the discharge cannula (81) of the dispensing and spraying member (19) being connected to the second cleaning assembly (17).

9. The cleaning system (10) according to the preceding claim, which comprises a drive device (21) in simultaneous rotation, about a common axis of rotation (100), with the first cleaning assembly (15) and with the second cleaning assembly (17), the drive device (21) comprising at least the fastening bearing (27) on which each of the cleaning assemblies is fastened, the fastening bearing (27) being configured to bear the dispensing and spraying member (19).

10. An optical assembly (5) for a vehicle, comprising at least one sensor block (9) and the cleaning system (10) according to any one of claims 8 and 9, the sensor block (9) comprising at least the first optical sensor (11) and the second optical sensor (13) superimposed on each other along the axis of rotation (100) of the cleaning system (10), the first optical sensor (11) comprising the first optical surface (35) and the second optical sensor (13) comprising the second optical surface (37), a first longitudinal dimension (350) of the first optical surface (35), substantially parallel to the axis of rotation (100), being less than a second longitudinal dimension (370) of the second optical surface (37), the cleaning system (10) comprising the first cleaning assembly (15) intended for cleaning the first optical surface (35) and the second cleaning assembly (17) intended for cleaning the second optical surface (37).
